(19) United States
(12) Patent Application Publication
(10) Pub. No.: US 2020/0014525 A1
(43) Pub. Date: Jan. 9, 2020

(54) METHOD FOR TIME SYNCHRONIZATION BETWEEN TWO COMPUTING DEVICES OF A DRIVER ASSISTANCE SYSTEM, DRIVER ASSISTANCE SYSTEM, AND MOTOR VEHICLE

(71) Applicant: Connaught Electronics Ltd., Tuam (IE)

(72) Inventors: Mohammed Nasr, Tuam (IE); Ganapathi Ramachandra, Tuam (IE); Mutlu Aydin, Tuam (IE); Manikandan Erachan, Tuam (IE)

(73) Assignee: Connaught Electronics Ltd., Tuam (IE)

(21) Appl. No.: 16/026,494

(22) Filed: Jul. 3, 2018

(51) Int. Cl. H04L 7/00; B60W 30/06; G05D 1/02

(52) U.S. Cl. CPC H04L 7/0016; G05D 2201/0213; G05D 1/021; B60W 30/06

(57) ABSTRACT

A method for time synchronization between a first electronic computing device of a driver assistance system of a motor vehicle and at least a second electronic computing device of the driver assistance system is disclosed. The method includes: generating, by the first electronic computing device, an interrupt signal and a first timestamp of the first clock; sending the interrupt signal to the second electronic computing device; generating, by the second electronic computing device, a second timestamp of the second clock, depending on the received interrupt signal; determining the time difference based on a difference of the two timestamps; and performing time synchronization depending on the determined time difference.

### BACKGROUND OF INVENTION

### Field of the Invention

The invention generally relates to time synchronization between electronic devices. More specifically, the invention relates a method for time synchronization between a first electronic computing device of a driver assistance system of a motor vehicle and at least a second electronic computing device of the driver assistance system, a driver assistance system, and a motor vehicle.

### Background Art

In driver assistance systems which depend on two different sensor data inputs, for example from an ultrasonic sensor device and from a camera device, an accurate and highly precise time synchronization between the respective electronic computing devices of the sensor devices is required.

It is known from the prior art that a Precision Time Protocol (PTP) message is used for time synchronization. This is a network protocol, which causes the synchronicity of the time settings of the electronic computing devices within the driver assistance system.

In the operation of the PTP protocol, an electronic computing device respectively distributes the time signal to a further electronic computing device for ascertaining the delay. Thereto, a timestamp in the form of a sync message (synchronous message) is sent from the clock of the first electronic computing device to the clock of the second electronic computing device, which determines the time of reception of the timestamps on its own time. In addition, the second electronic computing device repeatedly sends a delay request message to the first electronic computing device, the time of reception of which at the first electronic computing device is again sent back as a delay response message to the second electronic computing device.

Thus, the time differences from the first electronic computing device and the second electronic computing device and from the second electronic computing device to the first electronic computing device are determined from respectively the differences of the four time marks/timestamps. Thus, the difference of the two clocks and the message transit time with opposite sign are respectively contained in these values. The average value of the two quantities thus provides the directed offset (time difference) to the first electronic computing device, which is finally used for synchronizing.

Therein, the compensation for the transit times relies on the assumption that forward and return paths of synchronization messages according to the PTP method have identical average transit times and only slowly change over time. The approximation of the second electronic computing device to the reference time of the first electronic computing device is continuously effected via a control method.

In particular in time-critical situations or time-critical functions, which in particular occur for example at high speeds of the motor vehicle during the motor vehicle operation, the assumption that the forward and return paths of the synchronization messages are the same may no longer be accepted since inaccuracies may here occur. Upon assumption of these identical transit times, critical situations may in particular occur at high speeds of the motor vehicle since the sensor devices of the driver assistance system are not correspondingly precisely synchronized.

### SUMMARY OF INVENTION

The present invention provides a method, a driver assistance system as well as a motor vehicle, by means of which the time synchronization between two electronic computing devices of the driver assistance system may be more accurately performed. The present invention may advantageously improve accuracy of calculation of the time difference between two devices in order to have accurate time stamping of data shared between the devices. Particularly, in scenarios where the data is time sensitive, and the two devices are not powered up at the same time, have different time reference points, and run off different crystals which lead to different shift in the clocks.

An aspect of the invention relates to a method for time synchronization between a first electronic computing device of a driver assistance system of a motor vehicle and at least a second electronic computing device of the driver assistance system. A time difference between a first clock of the first electronic computing device and a second clock of the second electronic computing device is determined and the time synchronization is performed depending on the determined time difference.

An interrupt signal and a first timestamp of the first clock are generated by means of the first electronic computing device, and the interrupt signal is sent to the second electronic computing device. Depending on the received interrupt signal, a second timestamp of the second clock is generated by means of the second electronic computing device and the time difference is determined based on a difference of the two timestamps.

Accordingly, the second electronic computing device is notified by means of the interrupt signal of the first electronic computing device when it is to generate a current timestamp. The first timestamp and the second timestamp may be generated at the same time by means of the interrupt signal. If the two clocks of the two electronic computing devices should for example then have different times, for example due to different starting times of the individual electronic computing devices and/or different quartz crystals for timing within the electronic computing devices, then the time difference between the timestamps obtained at the same time may thereby be determined, whereby a time synchronization of the two electronic computing devices may then in turn be precisely performed. For example, the second clock of the second electronic computing device may then be correspondingly adapted to the first clock of the first electronic computing device. This may result in a precise time synchronization between the at least two electronic computing devices, whereby the driver assistance system may be more robustly configured, in particular at high speeds of the motor vehicle.

In other words, a transmission time from the first electronic computing device to the second electronic computing device and from the second electronic computing device to the first electronic computing device may be neglected since the interrupt signal is a physical connection between the physical components. In particular, the interrupt signal may also be referred to as “hardware interrupt”. In particular, it may be allowed by the method according to the invention that an accurate and precise synchronization process between the two electronic computing devices may thus be performed. This may result in an increase of the safety in the road traffic in particular in a drive operation with higher speeds, for example higher than 10 kilometers per hour, since the corresponding data for fusion within the driver assistance system is better matched to each other in time such that an evaluation of the environment may be performed in improved manner. In particular, the interrupt signal does not need to have a message structure, but may be formed as an electrical high signal or as an electrical low signal only.

The ascertained time difference may in particular also be referred to as offset. Further, it may be provided that the time synchronization may be performed with a further and/or with a plurality, in particular more than one, electronic computing device.

According to one or more embodiments, the second timestamp may be sent from the second electronic computing device to the first electronic computing device, and the first electronic computing device may determine the time difference by subtracting the first timestamp from the second timestamp or by subtracting the second timestamp from the first timestamp. Thereby, the time difference may be reliably determined within the first electronic computing device. In particular, the time difference is to be regarded as the magnitude of the subtraction. For example, if the first electronic computing device should be formed as a so-called master and the second electronic computing device should be formed as a so-called slave, then the master may determine the corresponding time difference and correspondingly consider it in fusing the respective data of the first electronic computing device and the second electronic computing device. This may result in an improved time synchronization of the first electronic computing device with the second electronic computing device.

According to one or more embodiments, the first timestamp is sent from the first electronic computing device to the second electronic computing device, and the second electronic computing device determines the time difference by subtracting the first timestamp from the second timestamp or by subtracting the second timestamp from the first timestamp. Thereby, the corresponding time difference may be determined also within the second electronic computing device. In particular, the respective time difference may be determined within both electronic computing devices. Thus, both electronic computing devices may perform a time synchronization or both electronic computing devices may be informed with respect to the time difference, which may then be considered in a respective evaluation of the respective electronic computing device. This may result in a redundant determination of the time difference, which may then in turn be sent for example to a superior driver assistance system. Thereby, a reliable time synchronization between the two electronic computing devices may be allowed.

According to one or more embodiments, a current evaluation process of the second electronic computing device may be, in particular immediately, interrupted based on the interrupt signal and the second timestamp may be generated. A so-called interrupt routine is quasi performed upon the interrupt signal. This interrupt routine, which is also referred to as interrupt service routine, is triggered by the interrupt signal. An evaluation, for example a sensor evaluation, of the second electronic computing device is immediately interrupted and the timestamp is generated. In other words, as soon as the interrupt signal has been received by the second electronic computing device, the timestamp is generated. This may result in that the first timestamp of the first electronic computing device and the second timestamp of the second electronic computing device are simultaneously generated such that the two timestamps are generated without time delay and the corresponding time difference may be determined without transmission losses. This may result in an accurate and precise time difference determination such that a time synchronization of the two electronic computing devices may be performed in improved manner.

According to one or more embodiments, the current evaluation process of the second electronic computing device is, in particular immediately, continued after the generation of the second timestamp. In other words, the evaluation of the second electronic computing device is immediately continued after the generation of the timestamp. In still other words, the interrupt signal is an interrupt service routine known from information, in which the normal or already begun evaluation may be continued after receiving the corresponding interrupt signal. The second electronic computing device quasi memorizes the interrupt point of time and continues the evaluation exactly at the location before the interrupt point of time. Thereby, the time synchronization between the two electronic computing devices may nevertheless be reliably performed without information loss with respect to the evaluation of the second electronic computing device.

According to one or more embodiments, the interrupt signal is transmitted to the second electronic computing device by means of a digital input/output device. In other words, only a binary signal may be sent via the digital input/output device. Thereby, the second electronic computing device is allowed in simplified manner to capture the trigger signal, namely the interrupt signal. For example, the digital signal may then be transmitted via a logic zero or via a logic one. For example, the interrupt signal may be identified if a logic one, for example a voltage between 2.5 and 5 volts, is captured across the digital input/output device. An interrupt signal is not applied if for example 0 volts is captured as the voltage at the input/output device by the second electronic computing device. Alternatively, it is also possible that the interrupt signal is recognized if a voltage is not applied, thus a logic zero, and a logic one may be identified as no interrupt signal. It is also possible that the voltages are correspondingly interchanged. In other words, it is possible that, for example, a logic zero is applied between 2.5 and 5 volts and a logic one is applied at 0 volts. Thereby, the interrupt signal may be physically transmitted from the first electronic computing device to the second electronic computing device in simple manner without time delay such that the two timestamps may be simultaneously generated, which results in an accurate and precise determination of the time difference between the two electronic computing devices. Besides the communication by means of the digital input/output device, further transmission devices of the interrupt signal are also possible.

According to one or more embodiments, the second timestamp and/or the first timestamp are sent from the second electronic computing device to the first electronic computing device and/or from the first electronic computing device to the second electronic computing device by means of a serial-peripheral interface. Thereby, a simple communication possibility between the two electronic computing devices is provided. Thus, the information of the two timestamps may be transmitted from the first electronic computing device to the second electronic computing device and from the second electronic computing device to the first electronic computing device, respectively, in simple manner. Further communication possibilities between the two electronic computing devices are also possible between the serial-peripheral interface.

According to one or more embodiments, an at least partially autonomous drive operation, in particular a fully autonomous drive operation, of the motor vehicle may be performed by means of the driver assistance system. In particular in the at least partially autonomous, in particular in the fully autonomous, drive operation, the time synchronization of the two electronic computing devices, which may in particular be associated with respective sensor devices, is important. In particular in the fusion of the different sensor devices, for example a lidar sensor device and an ultrasonic sensor device, the corresponding sensor data has to be conditioned with the corresponding timestamp for the fusion. For example, a lidar sensor may capture the periphery with a higher speed due to the speed of the laser beams than the ultrasonic sensor due to the speed of the ultrasonic waves. Therefore, it is important that the corresponding sensor data has a corresponding timestamp when they were captured. Therefore, it is important that the corresponding data is synchronized in time. Only then, the superior driver assistance system may precisely associate the respective data of the respective sensors with the corresponding points of time such that an improved peripheral capture by means of the driver assistance system is allowed. In particular in the partially autonomous, in particular in the fully autonomous, operation, it is important that the periphery or the environment of the motor vehicle may be correspondingly accurately and precisely captured to thus prevent critical situations. Thus, a time synchronization between the two electronic computing devices may be performed in improved manner by the method according to the invention in particular in the partially autonomous operation, in particular in the fully autonomous operation, such that an improved peripheral capture is allowed especially in these operating modes.

According to one or more embodiments, an at least partially autonomous parking procedure is performed as the drive operation of the motor vehicle by means of the driver assistance system. In particular in the parking procedure, the fusion of different sensor types is important. For example, information for the parking procedure from a camera device may be fused with information of an ultrasonic sensor device for the parking procedure. By the time synchronization between the two electronic computing devices, thus, the parking procedure may be performed in improved manner. Thereby, a reliable parking assistant as the driver assistance system is allowed.

According to one or more embodiments, the time synchronization is performed in an at least partially autonomous drive operation with a speed of greater than 10 kilometers per hour. In particular at speeds of greater than 10 kilometers per hour, delays due to the transmission with PTP messages are not acceptable because a great distance loss and thereby a great inaccuracy is associated with this time loss in particular at great speeds. This may result in the fact that critical situations are prevented due to the method according to the invention since a reliable time synchronization between the two electronic computing devices may be performed by means of the method according to the invention.

According to one or more embodiments, the first electronic computing device may be provided for a first capturing device of the driver assistance system and the second electronic computing device may be provided for a second capturing device of the driver assistance system different from the first capturing device. In particular, the environment of the motor vehicle may then be captured by means of two different capturing devices. By the improved time synchronization, the corresponding respective information of the respective capturing devices may then be fused in improved manner. Thereby, improved environmental recognition is allowed.

According to one or more embodiments, the first capturing device is provided as a camera device of the driver assistance system and the second capturing device is provided as an ultrasonic sensor device of the driver assistance system or the second capturing device is provided as a camera device of the driver assistance system and the first capturing device is provided as an ultrasonic sensor device of the driver assistance system. Thereby, the environment of the motor vehicle may be captured in different capturing manners. The camera device and the ultrasonic sensor device then in particular capture the environment with different speeds of the information generation. Upon fusion of the information of the ultrasonic sensor device with the camera device, the corresponding information then has to be synchronized with each other to also be able to utilize the corresponding information of the two devices. The information has to be able to be associated with each other in time. Due to the time synchronization according to the method according to the invention, thus, the two information of the ultrasonic sensor device and the camera device may be fused in improved manner. Thereby, an improved environmental capture of the motor vehicle is allowed, whereby in particular an at least partially autonomous or a fully autonomous drive operation of the motor vehicle may be realized.

A further aspect of the invention relates to a driver assistance system with at least a first electronic computing device and with at least a second electronic computing device, wherein the driver assistance system is formed for performing the method according to the preceding aspect. In particular in a fully autonomous drive operation of the motor vehicle, the driver assistance system may also be referred to as electronic vehicle driving system.

A still further aspect of the invention relates to a motor vehicle with a driver assistance system according to the preceding aspect. The motor vehicle is in particular formed as a passenger car.

Embodiments of the method may be embodied into the driver assistance system and the motor vehicle. Thereto, the driver assistance system as well as the motor vehicle has concrete features, which allow performing the method.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone without departing from the scope of the invention. Thus, implementations are also to be considered as encompassed and disclosed by the invention, which are not explicitly shown in the figures and explained, but arise from and may be generated by the separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF DRAWINGS

FIG. 1 is a schematic top view of a motor vehicle with a driver assistance system according to one or more embodiments;

FIG. 2 is a schematic flow diagram of the time synchronization of the driver assistance system according to one or more embodiments; and

FIG. 3 is a schematic top view of two electronic computing devices of the driver assistance system according to one or more embodiments.

FIG. 4 is a flow chart of the steps for performing the method according to one or more embodiments.

FIG. 5 is a block diagram of a computing system in which embodiments of the invention may be implemented.

In the figures, identical or functionally identical elements are provided with the same reference characters.

### DETAILED DESCRIPTION

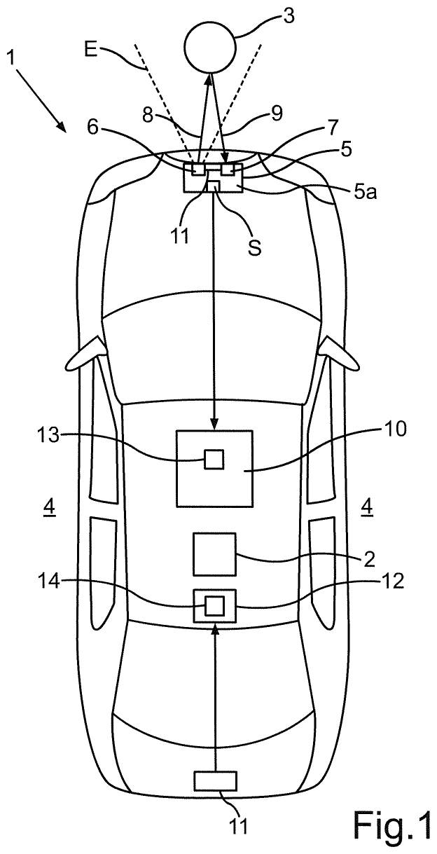

FIG. 1 shows a motor vehicle 1 according to one or more embodiments of the invention. In the present embodiment, the motor vehicle 1 is designed as a passenger car. The motor vehicle 1 comprises a driver assistance system 2. For example, the driver assistance system 2 may be used to detect an object 3 located in the environment 4 of the motor vehicle 1. In particular, the driver assistance system 2 may be used to determine the distance between the motor vehicle 1 and the object 3.

The driver assistance system 2 comprises at least one ultrasonic sensor device 5. The ultrasonic sensor device 5 has at least one ultrasonic sensor 5a. The ultrasonic sensor 5a comprises a transmitting device 6, by means of which at least one ultrasonic signal 8, in particular several ultrasonic signals 8, may be transmitted. FIG. 1 for example shows an ultrasonic sensor device 5 with an ultrasonic sensor 5a in a front area of the motor vehicle 1. Another ultrasonic sensor device 5 is arranged on a rear area of the motor vehicle 1, is also shown as an example. The ultrasonic sensor device 5 at the rear has four ultrasonic sensors 5a, for example.

With the transmitting device 6, the ultrasonic signals 8 may be transmitted within a predetermined detection range E or a predetermined angular range by means of a membrane. The membrane is especially coupled to a transducer element 11, by means of which electrical signals may be converted into ultrasonic signals 8 during transmission and echo signals 9 into electrical signals during reception. For example, the transducer element 11 may be a piezo element.

In addition, the ultrasonic sensor device 5 comprises a receiving device 7 by means of which reflected ultrasonic signals may be received as echo signals 9, which have been reflected from the object 3, in particular via the membrane. Therefore, the ultrasonic signals reflected from the object 3 may be received as a received signal with the receiving device 7. In addition, the ultrasonic sensor device 5 may have a control device S, which may be formed, for example, by a microcontroller and/or a digital signal processor. The driver assistance system 2 also comprises a control device 10, which may, for example, consist of an electronic control unit (ECU) of the motor vehicle 1. The control unit 10 is connected to the ultrasonic sensor device 5 for data transmission. The data transmission may take place, for example, via the data bus of the motor vehicle 1.

Further, the motor vehicle 1 comprises a camera device 11. The camera device 11 is formed for optically capturing the environment 4 of the motor vehicle 1. In the present embodiment, the camera device 11 is formed at the rear area of the motor vehicle 1. The camera device 11 is coupled to a second electronic computing device 12, which may for example be an electronic controller for image evaluation. The ultrasonic device 5 and the camera device 11 may in particular be a part of the driver assistance system 2.

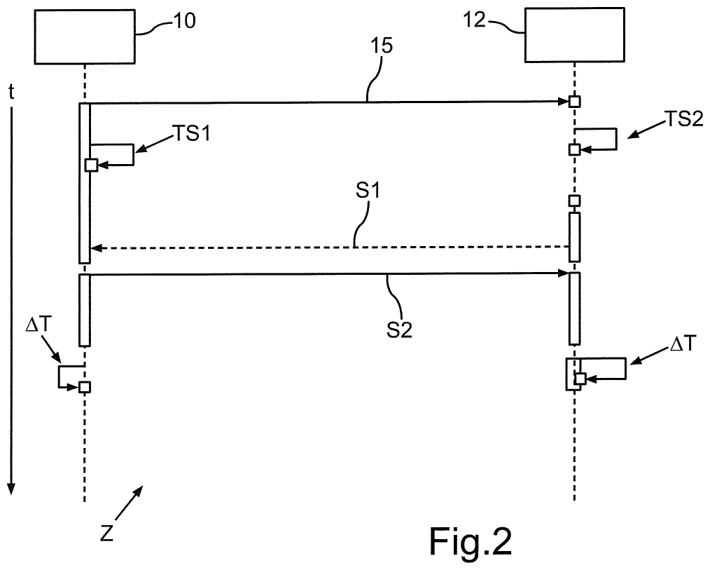

In the method for time synchronization Z (FIG. 2) between the first electronic computing device 10 of the driver assistance system 2 of the motor vehicle 1 and the at least second electronic computing device 12 of the driver assistance system 2, a time difference ΔT between a first clock 13 of the first electronic computing device 10 and a second clock 14 of the second electronic computing device 12 is determined and the time synchronization Z is performed depending on the determined time difference ΔT.

An interrupt signal 15 (FIG. 2) is generated and a first timestamp TS1 (FIG. 2) of the first clock 13 is generated by means of the first electronic computing device 10. The interrupt signal 15 is sent to the second electronic computing device 12 and a second timestamp TS2 (FIG. 2) of the second clock 14 is generated by means of the second electronic computing device 12 depending on the received interrupt signal 15 and the time difference ΔT is determined based on a difference of the two timestamps TS1, TS2.

For example, the interrupt signal 15 may be generated by raising a hardware (HW) pin on the first electronic computing device 10. The first electronic computing device 10 then takes a first timestamp TS1 of the first clock 13. When the second electronic computing device 12 detects that the HW pin is set, the second electronic computing device 12 raises an interrupt that triggers an interrupt service routine. The interrupt service routine takes a second timestamp TS2 of the second clock 14, and sent the second timestamp TS2 to the first electronic computing device 10. The first electronic computing device 10 calculates the time difference ΔT by subtracting the two timestamps TS1 and TS2.

In particular, it may be provided that an at least partially autonomous drive operation, in particular a fully autonomous drive operation, of the motor vehicle 1 is performed by means of the driver assistance system 2. In particular in a fully autonomous drive operation of the motor vehicle 1, the driver assistance system 2 may also be referred to as electronic vehicle driving system. For example, an at least partially autonomous parking procedure may be performed as the drive operation of the motor vehicle 1 by means of the driver assistance system 2.

As already mentioned, the first electronic computing device 10 is in particular a computing device of a first capturing device, presently of the ultrasonic sensor device 5. As also already described, the second electronic computing device 12 is a computing device of a second capturing device of the driver assistance system 2. The two capturing devices are in particular differently formed. In the following embodiment, as already described, the first capturing device is formed as an ultrasonic sensor device 5 and the second capturing device is formed as a camera device 11. Besides these capturing devices, further capturing devices such as for example a lidar sensor device or a radar sensor device are also possible.

FIG. 2 shows a flow diagram of the method according to one or more embodiments of the invention. In the following embodiment, the interrupt signal 15 is transmitted to the second electronic computing device 12 by the first electronic computing device 10. The first timestamp TS1 is generated by the first electronic computing device 10. Depending on the received interrupt signal 15, the second timestamp TS2 is generated by the second electronic computing device 12.

In particular, it may be provided that the second timestamp TS2 is sent to the first electronic computing device 10 by the second electronic computing device 12 in a step S1 and the first electronic computing device 10 determines the time difference ΔT by subtracting the first timestamp TS1 from the second timestamp TS2 or by subtracting the second timestamp TS2 from the first timestamp TS1.

Alternatively or additionally, it may be provided that the first timestamp TS1 is sent to the second electronic computing device 12 by the first electronic computing device 10 in step S2 and the second electronic computing device 12 determines the time difference ΔT by subtracting the first timestamp TS1 from the second timestamp TS2 or by subtracting the second timestamp TS2 from the first timestamp TS1.

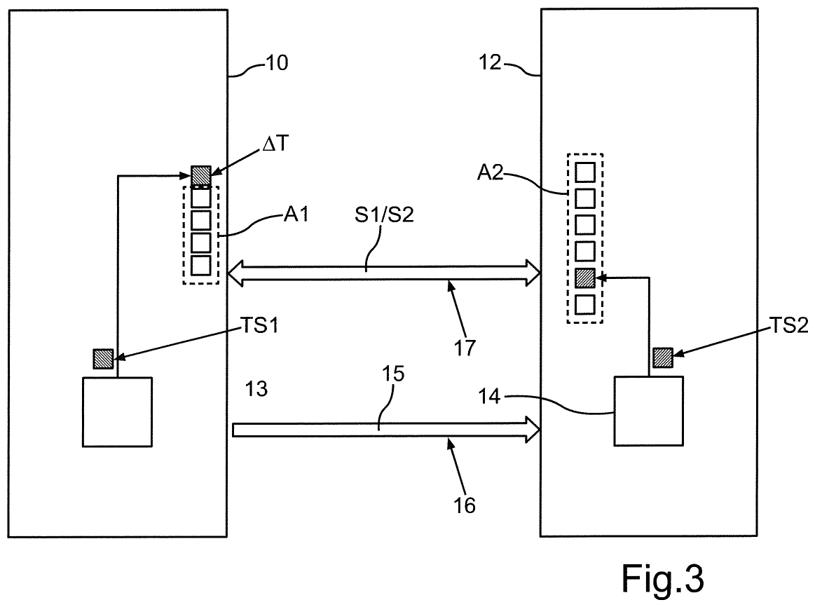

FIG. 3 schematically shows an embodiment of the driver assistance system 2 with the two electronic computing devices 10, 12 in a top view. In FIG. 3, the communication between the first electronic computing device 10 and the second electronic computing device 12 is in particular shown.

In the present embodiment, the interrupt signal 15 is in particular transmitted to the second electronic computing device 12 by means of a digital input/output device 16. In particular, it is a so-called hardware interrupt. In other words, only a binary signal may be sent via the digital input/output device 16. Thereby, the second electronic computing device 12 is allowed in simplified manner to capture the trigger signal, namely the interrupt signal 15. For example, the digital signal may then be transmitted via a logic zero or via a logic one. For example, the interrupt signal 15 may be identified if a logic one, for example a voltage between 2.5 and 5 volt, is captured across the digital input/output device 16. An interrupt signal 15 is not applied if for example 0 volts is captured as the voltage by the second electronic computing device 10 at the input/output device 16. Alternatively, it may also be possible that the interrupt signal 15 is recognized if a voltage is not applied, thus a logic zero, and a logic one may be identified as no interrupt signal 15. It is also possible that the voltages are correspondingly interchanged. In other words, it is possible that for example a logic zero is applied between 2.5 and 5 volts and a logic zero is applied at 0 volts. Thereby, the interrupt signal 15 may be transmitted from the first electronic computing device 10 to the second electronic computing device 12 without time delay in simple manner such that the two timestamps TS1, TS2 may be simultaneously generated, which results in an accurate and precise determination of the time difference ΔT between the two electronic computing devices 10, 12. Besides the communication by means of the digital input/output device 16, further transmission devices of the interrupt signal 15 such as cable and conductive wire are also possible.

Further, FIG. 3 shows that the second timestamp TS2 and/or the first timestamp TS1 may be sent from the second electronic computing device 12 to the first electronic computing device 10 and/or from the first electronic computing device 10 to the second electronic computing device 12 by means of a serial-peripheral interface 17. Further communication possibilities are also given between the first electronic computing device 10 and the second electronic computing device 12.

Further, FIG. 3 shows that a respective electronic computing device 10, 12 has a respective evaluation process A1, A2. Therein, the first electronic computing device 10 has the first evaluation process A1 and the second electronic computing device 12 therein has the second evaluation process A2. The respective evaluation processes A1, A2 may in particular be for example the evaluation of the respective captured sensor data of the respective capturing devices.

In particular, it is shown in FIG. 3 that a current evaluation process A2 of the second electronic computing device 12 is, in particular immediately, interrupted based on the interrupt signal 15 and the second timestamp TS2 is generated. In other words, the interrupt signal 15 is a so-called interrupt service routine. A corresponding evaluation within the second electronic computing device 12 is immediately stopped after receiving the interrupt signal 15 and the timestamp TS2 is generated. FIG. 3 shows how the second timestamp TS2 is inserted into the evaluation sequence of the evaluation process A2. In particular, the current evaluation process A2 of the second electronic computing device 12 is, in particular immediately, continued after the generation of the second timestamp TS2. In other words, the evaluation sequence is directly continued at that location, where it was previously interrupted, after the generation of the second timestamp TS2.

Further, it is shown in FIG. 3 that for example the generation of the time difference ΔT may be performed only after the first evaluation process A1. The time synchronization Z of the two electronic computing devices 10, 12 may then be performed by means of the ascertained time difference ΔT.

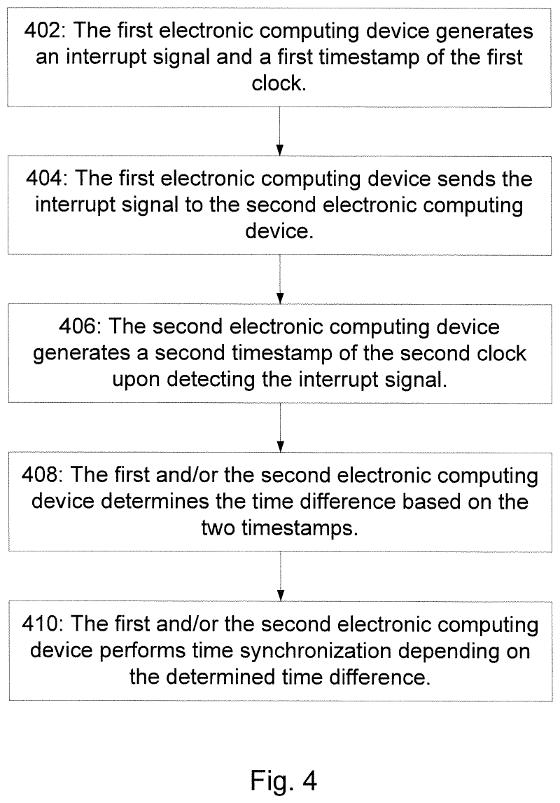

FIG. 4 provides a flow chart that summarizes the steps for performing the method according to one or more embodiments of the present invention, including the embodiments described above.

At step 402, the first electronic computing device generates an interrupt signal and a first timestamp of the first clock.

At step 404, the first electronic computing device sends the interrupt signal to the second electronic computing device.

At step 406, the second electronic computing device generates a second timestamp of the second clock upon detecting the interrupt signal.

At step 408, the first and/or the second electronic computing device determines the time difference based on the two timestamps.

At step 410, the first and/or the second electronic computing device performs time synchronization depending on the determined time difference.

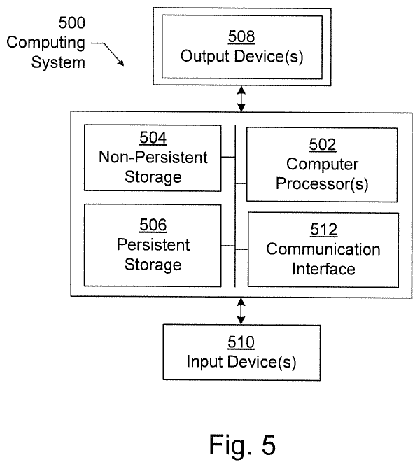

Embodiments of the invention may be implemented on virtually any type of computer regardless of the platform being used. For example, as shown in FIG. 5, a computer system (500) includes one or more processor(s) (502), associated memory (504) (e.g., random access memory (RAM), cache memory, flash memory, etc.), a storage device (506) (e.g., a hard disk, an optical drive such as a compact disk drive or digital versatile disk (DVD) drive, a flash memory stick, etc.), and numerous other elements and functionalities typical of today's computers (not shown). In one or more embodiments of the invention, the processor (502) is hardware. For example, the processor may be an integrated circuit. The computer system (500) may also include input means, such as a keyboard (508), a mouse (510), or a microphone (not shown). Further, the computer system (500) may include output means, such as a monitor (512) (e.g., a liquid crystal display (LCD), a plasma display, or cathode ray tube (CRT) monitor). The computer system (500) may be connected to a network (e.g., a local area network (LAN), a wide area network (WAN) such as the Internet, or any other type of network) via a network interface connection (not shown). Many different types of computer systems exist, and the aforementioned input and output means may take other forms. Generally speaking, the computer system (500) includes at least the minimal processing, input, and/or output means necessary to practice embodiments of the invention.

Software instructions in the form of computer readable program code to perform embodiments of the invention may be stored, in whole or in part, temporarily or permanently, on a computer readable medium such as a compact disc (CD), a diskette, a tape, physical memory, or any other computer readable storage medium. Specifically, the software instructions may correspond to computer readable program code that when executed by a processor(s), is configured to perform embodiments of the invention. In one or more embodiments of the invention, the computer readable medium is a non-transitory computer readable medium.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A method for time synchronization between a first electronic computing device of a driver assistance system of a motor vehicle and at least a second electronic computing device of the driver assistance system, the method comprising:
generating, by the first electronic computing device, an interrupt signal and a first timestamp of the first clock;
sending the interrupt signal to the second electronic computing device;
generating, by the second electronic computing device, a second timestamp of the second clock, depending on the received interrupt signal;
determining the time difference based on a difference of the two timestamps; and
performing time synchronization depending on the determined time difference.

2. The method according to claim 1, further comprising:
after generating the second timestamp, sending the second timestamp to the first electronic computing device by the second electronic computing device,
wherein the time difference is determined, by the first electronic computing device, by subtracting the first timestamp from the second timestamp or by subtracting the second timestamp from the first timestamp.

3. The method according to claim 1, further comprising:
after generating the first timestamp, sending the first timestamp to the second electronic computing device by the first electronic computing device,
wherein the time difference is determined, by the second electronic computing device, by subtracting the first timestamp from the second timestamp or by subtracting the second timestamp from the first timestamp.

4. The method according to claim 1,
wherein, at the time of sending the interrupt signal, a current evaluation process of the second electronic computing device is interrupted and the second timestamp is generated.

5. The method according to claim 4, further comprising
continuing the current evaluation process of the second electronic computing device after the generation of the second timestamp.

6. The method according to claim 1,
wherein the interrupt signal is transmitted to the second electronic computing device by a digital input/output device.

7. The method according to claim 1,
wherein the second timestamp and/or the first timestamp are sent from the second electronic computing device to the first electronic computing device and/or from the first electronic computing device to the second electronic computing device by a serial-peripheral interface.

8. The method according to claim 1, further comprising:
performing an at least partially autonomous drive operation of the motor vehicle by the driver assistance system.

9. The method according to claim 8,
wherein the drive operation is an at least partially autonomous parking procedure.

10. The method according to claim 8,
wherein the time synchronization is performed in the drive operation with a speed of greater than 10 km/h.

11. The method according to claim 1,
wherein the first electronic computing device is provided for a first capturing device of the driver assistance system, and the second electronic computing device is provided for a second capturing device different from the first capturing device of the driver assistance system.

12. The method according to claim 11,
wherein the first capturing device is provided as a camera device of the driver assistance system and the second capturing device is provided as an ultrasonic sensor device of the driver assistance system, or the second capturing device is provided as a camera device of the driver assistance system and the first capturing device is provided as an ultrasonic sensor device of the driver assistance system.

13. A driver assistance system comprising:
at least a first electronic computing device and a second electronic computing device,
wherein the driver assistance system is configured to:
generate, by the first electronic computing device, an interrupt signal and a first timestamp of the first clock,
send the interrupt signal to the second electronic computing device,
generate, by the second electronic computing device, a second timestamp of the second clock, depending on the received interrupt signal,
determine the time difference based on a difference of the two timestamps, and
perform time synchronization depending on the determined time difference.

14. A motor vehicle with a driver assistance system according to claim 13.
